(19) United States
(12) Patent Application Publication
(10) Pub. No.: US 2025/0384279 A1
(43) Pub. Date: Dec. 18, 2025

(54) Conversational Artificial Intelligence (AI) System with Transactional Capabilities

(71) Applicant: SAP SE, Walldorf (DE)

(72) Inventors: Qiu Shi Wang, Singapore (SG); Lin Cao, Singapore (SG)

(21) Appl. No.: 18/742,549

(22) Filed: Jun. 13, 2024

(51) Int. Cl. G06N 3/0895; G06N 5/022

(52) U.S. Cl. CPC G06N 3/0895; G06N 5/022

(57) ABSTRACT

A conversational artificial intelligence (AI) system is provided that enables the users of a software application to perform application tasks (and in particular, initiate data transactions against a backend data store) using natural language. In one set of embodiments, the system can automatically collect user interaction data from the software application “on-the-fly,” while the users interact with the application via the application's conventional UI workflows. The system can then use this collected user interaction data to process user natural language requests via a retrieve-augment-generate (RAG) approach that leverages a large language model (LLM).

### BACKGROUND

Business applications are software applications that are used by organizations to manage and support their business processes. Examples of business applications include enterprise resource planning (ERP) applications, customer relationship management (CRM) applications, financial management applications, and so on.

Traditionally, the users of a business application interact with the application via a set of user interfaces (UIs) known as pages. For instance, consider a scenario in which a user of a CRM application wishes to update the details of a particular customer. In this scenario, the user will typically navigate to a “customer details” page of the CRM application for that customer and interact with various user interface controls (e.g., text input fields, drop down menus, buttons, etc.) presented on the page in order to enter the updated customer information. As part of this UI workflow, the user may need to navigate to several additional pages, such as a page dedicated to editing customer address, a page dedicated to editing customer contact details, etc. Finally, after entering the updated customer information, the user will typically click on a “submit” button to initiate a data transaction that saves the entered information in a backend data store.

While this traditional user interaction paradigm is functional, it also suffers from several drawbacks. First, the process of navigating through potentially multiple pages and manually entering data on each page is cumbersome and time-consuming, particularly if it needs to be repeated many times (e.g., to update the details of many customers). Second, this paradigm is not intuitive; for example, a user that is unfamiliar with the application's UI workflows may have a difficult time understanding how to accomplish the specific task they have in mind.

### BRIEF DESCRIPTION OF THE DRAWINGS

FIG. 1 depicts an example environment.

FIGS. 2A, 2B, 2C, and 2D depict pages of a traditional application UI workflow.

FIG. 3 depicts a version of the environment of FIG. 1 that implements a conversational AI system according to certain embodiments.

FIG. 4 depicts a data collection flowchart according to certain embodiments.

FIG. 5 depicts a natural language input processing flowchart according to certain embodiments.

FIG. 6 depicts an example computer system according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

Embodiments of the present disclosure are directed to a conversational artificial intelligence (AI) system that enables the users of a software application to perform application tasks (and in particular, initiate data transactions against a backend data store) using natural language. For example, in certain embodiments the conversational AI system enables the users of a business application such an ERP application, a CRM application, or the like to initiate OData transactions against a backend database via natural language requests.

Significantly, this system does not require a data scientist to assemble a data set for training the system or a full-stack developer to create functions for executing the data transactions. Instead, as explained in further detail below, the system can automatically collect user interaction data from the software application “on-the-fly,” while the users interact with the application in a traditional manner (or in other words, via the application's conventional UI workflows). This user interaction data can be used to populate a knowledge database with text tokens and associated embeddings pertaining to the user interactions, as well as a transaction function list comprising transaction functions that are invoked by the application in response to those user interactions.

With this knowledge database and transaction function list in place, a user of the application can submit to the conversational AI system a natural (human) language request to perform some task within the application (such as, e.g., updating the email address of a given customer) that involves execution of a data transaction. In response, the system can employ a retrieve-augment-generate (RAG) approach to retrieve text tokens from the knowledge database that are semantically related to the user request; generate a prompt for a large language model (LLM) that includes the user request, the retrieved text tokens, and a request to generate a transaction function string that is responsive to the user request; and provide the prompt as input to the LLM, thereby causing the LLM to output the requested transaction function string. Finally, the system can match the LLM output to one of the transaction functions in the transaction function list and invoke the matched transaction function, resulting in execution of the data transaction.

### 1. Example Environment and Solution Overview

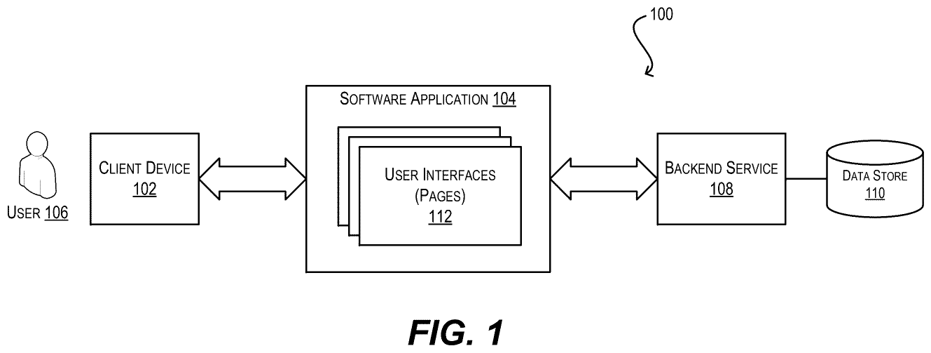

To provide context for the embodiments of the present disclosure, FIG. 1 depicts an example environment 100 comprising a client device 102 that is communicatively coupled with a software application (hereinafter simply “application”) 104. Client device 102 is operated by a user 106 of application 104 and may be a desktop computer, a laptop computer, a smartphone, a tablet, or any other type of end-user computer system or device. Application 104 may be a desktop application, a web application, a mobile application, or any other type of software application known in the art. In one set of embodiments, application 104 may be a business application (e.g., an ERP application, CRM application, etc.) that is deployed by an organization of which user 106 is a member/employee.

As shown, application 104 communicates with a backend service 108 that is connected to a data store 110 for application 104, such as a database or a key-value store. Application 104 invokes functions, also known as application programming interfaces or APIs, that are exposed by backend service 108 for executing data transactions (hereinafter simply “transactions”) against data store 110, such as querying or writing data. In response to such a function invocation, backend service 108 executes the corresponding transaction and returns the results to application 104. Backend service 108 and application 104 can use any of a number of protocols for this communication; for example, in embodiments where backend service 108 is implemented as an OData service, backend service 108 and application 104 can communicate via the OData protocol, such that application 104 invokes OData transaction functions and backend service 108 executes OData transactions against data store 110 in response to those function invocations.

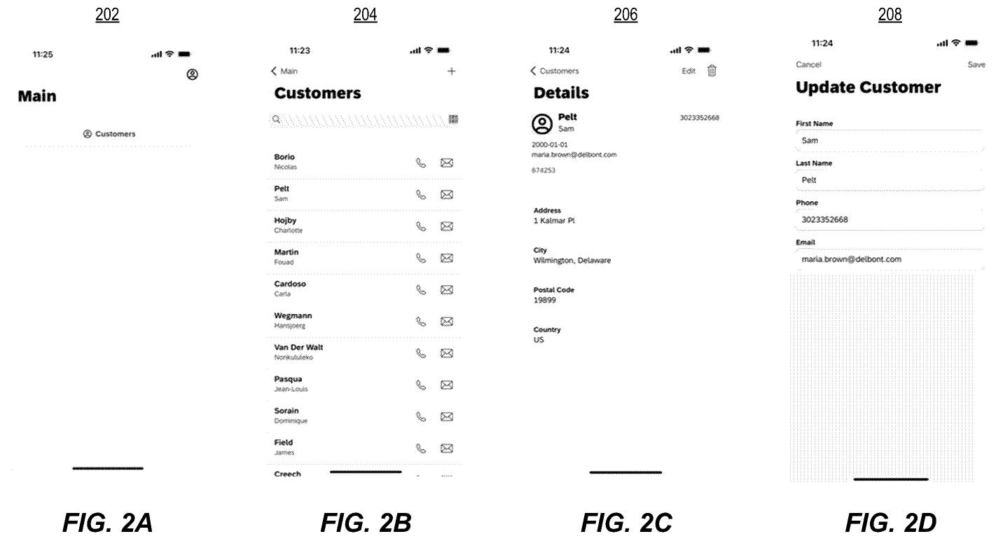

In a typical usage scenario, user 106 logs into application 104, navigates through one or more UIs (pages) 112 of the application, and interacts with UI controls that are presented on those pages in order to perform a task that results in execution of a data transaction against data store 110. For example, FIGS. 2A, 2B, 2C, and 2D depict a UI workflow comprising pages 202, 204, 206, and 208 respectively that user 106 may navigate through in order to update the email address of a customer named “Sam Pelt.” In this example, the user first accesses a “Main” page 202 of the application and clicks on the “Customers” item. This causes the application to display a “Customers” page 204, which lists all of the customers that are defined in the application. The user then searches for Sam Pelt within Customers page 204 and clicks on the list item for this customer, which causes the application to display a “Customer Details” page 206 that presents detailed information for Sam Pelt. The user then clicks on the “Edit” control within Customer Details page 206, which causes the application to display an “Update Customer” page 208 with editable customer information fields. Finally, the user enters an updated email address for Sam Pelt in the “Email” text input box and clicks on the “Save” control, which causes the application to invoke a transaction function exposed by backend service 108 for initiating a data write transaction that saves the updated email address for Sam Pelt in data store 110.

As noted in the Background section, the problems with this traditional user interaction paradigm are twofold. First, it is time-consuming, cumbersome, and repetitive. For example, if user 106 needs to update the email addresses of multiple customers, the user will need to repeat the foregoing steps for every customer. Second, this paradigm is unintuitive, as it requires user 106 to understand the details and peculiarities of the UI workflows created by the application designer. While the workflow described above and shown in FIGS. 2A-2D is fairly straightforward, it is common for software applications (and in particular, business applications) to implement more complex UI workflows that are difficult to navigate and understand without significant training.

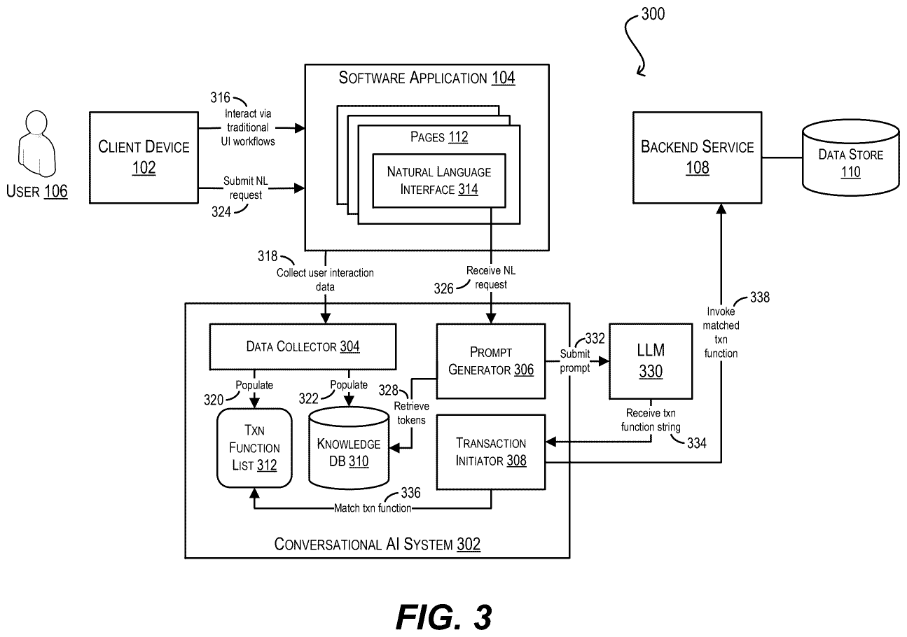

To address these and other similar problems, FIG. 3 depicts an enhanced version 300 of environment 100 of FIG. 1 that implements a novel conversational AI system 302 according to certain embodiments. As shown, conversational AI system 302 includes a data collector 304, a prompt generator 306, a transaction initiator 308, a knowledge database 310, and a transaction function list 312. System 302 also includes a natural language (e.g., chatbot) interface 314 that is presented on one or more of the application's pages 112. These system components may be implemented in software, in hardware, or a combination thereof.

At a high level, conversational AI system 302 enables user 106 to perform tasks and initiate transactions within application 104 via natural language requests, rather than via the application's traditional UI workflows. System 302 achieves this via two processes (which may run in sequence or in parallel): data collection and natural language input processing.

With respect to data collection, while user 106 and/or other users of application 104 interact with the application in a traditional manner (i.e., by accessing and interacting with the application's pages 112, shown via arrow 316), data collector 304 can autonomously collect user interaction data from the application (arrow 318). This user interaction data can include information pertaining to the interactions between the user(s) and pages 112, such as the particular pages visited, the UI controls manipulated or accessed on each page, the data that is entered into each UI control, and the transaction functions that are invoked by the application as a result of the user interactions. The user interaction data can further include information pertaining to the structure of pages 112, such as the hierarchical layout of UI controls/elements in each page and the data bindings for those elements. In one set of embodiments, this data can be collected from log files generated by application 104 during its runtime, as well as from metadata files of the application.

For instance, listing 1 below presents an example portion of the collected user interaction data that pertains to an OData transaction and listing 2 below presents an example portion of the collected user interaction data that pertains to a UI control.

```
Listing 1
{
  “uniqueId” : “bbd3dacb-c379-4634-906a-9175ff374a04”,
  “correlationId” : “f01b9dc0-6a9a-47c7-6168-3fd70c068b7b”,
  “timestamp” : “2024-04-18T05:52:16.518Z”,
  “severity” : 2,
  “sourceName” : “SAP.MDKClient”,
  “messageCode” : null,
  “component” : null,
  “applicationId” : “com.sap.dcom.demo”,
  “location” :
“~h64_dev_mac/src/SnowblindClientApplication/frameworks/SnowblindFra
mework/Foundation/Logger/SharedLogger.swift - log(_:message:)”,
  “username” : “demouser@sap.com”,
“transactionId” : null,
“transactionString”
:{“headers”:{“accept”:“application/json”,“content-
type”:“application/json”},“url”:“/Customers/?$filter=Name eq ‘John
Doe ’
”,“method”:“patch”,“data”:“{\“Email\”:\“john.doe@abc.com”}”}
  “rootContextId” : null,
  “messageText” : “Thu Apr 18 2024 13:52:16 GMT+0800 (+08)
update entity succeeded\n \\n Params :
{\“service\”:{\“offlineEnabled\”:true,\“serviceUrl\”:\“https://lcap-
qa-qa-com-sap-dcom-
demo.cfapps.sap.hana.ondemand.com/com.sap.edm.sampleservice.v4\”,\“s
tatefulService\”:false,\“uniqueIdType\”:0,\“keyProperties\”:[ ] ,\“hea
ders\”:{ },\“serviceHeaders\”:{ },\“entitySet\”:\“Customers\”,\“readLi
nk\”:\“Customers(674253)\”,\“serviceName\”:\“/DemoSampleApp/Services
/SampleServiceV4.service\”,\“properties\”:{\“EmailAddress\”:\“maria.
brown@delbont.com2\”,\“FirstName\”:\“Sam\”,\“LastName\”:\“Pelt\”,\“P
honeNumber\”:\“3023352668\”}},\“createLinks\”:[ ],\“updateLinks\”:[ ],
\“deleteLinks\”:[ ],\“headers\”:{ }}\\n\\n Result:
\“{\\\“@odata.type\”:\\\“_ESPM.Customer\\\”,\\\“@odata.editLink\\\
”:\\\“Customers(674253)\\\”,\\\“@odata.id\\\”:\\\“Customers(674253)\
\\”\\\“@odata.readLink\\\”:\\\“Customers(674253)\\\”,\\\“@sap.hasPe
ndingChanges\\\”:true,\\\“@sap.isLocal\\\”:true,\\\“@sap.isUpdated\\
\”:true,\\\“Address\\\”:{\\\“@odata.type\\\”:\\\“_ESPM.Address\\\”,\
\\“City\\\”:\\\“Wilmington,
Delaware\\\”,\\\“Country\\\”:\\\“US\\\”,\\\“HouseNumber\\\”:\\\“1\\\
”,\\\“PostalCode\\\”:\\\“19899\\\”,\\\“Street\\\”:\\\“Kalmar
Pl\\\”},\\\“City\\\”:\\\“Wilmington,
Delaware\\\”,\\\“Country\\\”:\\\“US\\\”,\\\“CustomerID\\\”:674253,\\
\“DateOfBirth\\\”:\\\“2000-01-
01\\\”,\\\“EmailAddress\\\”:\\\“john.doe@abc.com\\\”,\\\“FirstName\\
\”:\\\“John\\\”,\\\“Gender\\\”:\\\“Male\\\”,\\\“HouseNumber\\\”:\\\“
1\\\”,\\\“LastName\\\”:\\\“Doe\\\”,\\\“PhoneNumber\\\”:\\\“302335266
8\\\”,\\\“PostalCode\\\”:\\\“19899\\\”,\\\“Street\\\”:\\\“Kalmar
Pl\\\”}\””,
  “instanceId” : “d6b86c3b-6811-45ff-aa12-065a55088cc9”,
  “isTrialPlan” : false,
  “timeHours” : 475949,
  “created” : “2024-04-18T05:52:40.291Z”,
  “fileId” : “7283632e-d7c9-41ba-a8d2-68dd25a0b5f9”,
  “lineNumber” : 2671
}
Listing 2
{
  “uniqueId” : “5a7f79d5-c173-4a09-9507-fcd329a0eacb”,
  “correlationId” : “a59815a6-78a0-4798-5b0e-6a3f8db60772”,
  “timestamp” : “2024-03-05T07:28:40.855Z”,
  “severity” : 2,
  “sourceName” : “SAP.Fiori.Theming.FioriStyleable”,
  “messageCode” : null,
  “component” : null,
  “applicationId” : “com.sap.dcom.demo”,
  “location” : “/Users/admin/hyperspace-mobile-
newyork/_work/1/s/src/Frameworks/SAPFiori/SAPFiori/Theming/FioriStyl
eable_UIView.swift - nuiClass”,
  “username” : “demouser@sap.com”,
  “transactionId” : null,
  “rootContextId” : null,
  “messageText” : “nuiClass: object = < UILabel: 0x12c3fa4b0;
frame = (20 16; 100 40); text = ‘L...l’ (length = 5) ; opaque = NO;
autoresize = RM+BM; userInteractionEnabled = NO; layer =
<_UILabelLayer: 0x2826005a0>>; newValue =
Optional(\“fdlFontStyle_body:fdlSimplePropertyCollectionViewCell_key
Label:fdlFUISimplePropertyCollectionViewCell_keyLabel\”)”,
  “instanceId” : “d6b86c3b-6811-45ff-aa12-065a55088cc9”,
  “isTrialPlan” : false,
  “timeHours” : 474895,
  “created” : “2024-03-05T07:29:30.222Z”,
  “fileId” : “9e984ffe-e556-4d5b-8249-f4bf6dd29cb7”,
  “lineNumber” : 5490
}
```

Upon collecting the user interaction data, data collector 304 can populate knowledge database 310 and transaction function list 312 using this data (arrows 320 and 322). For example, for knowledge database 310, data collector 304 can split the textual content of the user interaction data into chunks (referred to as tokens), create a dense vector of each token that represents its semantic meaning (referred to as an embedding), and store each token and its corresponding embedding in the knowledge database. And for transaction function list 312, data collector 304 (through arrow 320) can extract transaction functions (or more precisely, invocations of transaction functions) that it finds in the user interaction data and can store these extracted transaction functions in the list. For instance, listing 3 below presents an OData transaction function that may be extracted from the user interaction data shown in listing 2 and included in transaction function list 312.

Listing 3

{“headers”:{“accept”:“application/json”,“content-
type”:“application/json”},“url”:“/Customers/?$filter=Name eq ‘John
Doe ’”,“method”:“patch”,“data”:“{\“Email\”:\“john.doe@abc.com”}”}

With respect to natural language input processing, at some point in time after knowledge database 310 and transaction function list 312 are populated, user 106 can submit a natural language request via natural language interface 314 for performing some task within application 104, where the task involves the execution of a data transaction against data store 110 (arrow 324). This natural language request may be submitted via various modalities, such as via voice input or via text input. For example, the following is sample natural language request that may be submitted by user 106 for updating the email address of a customer named “John Doe,” in the scenario where application 104 is a CRM application.

Listing 4

Please search for the customer named John Doe and update the email
address to john.doe@abc.com.

Prompt generator 306 of conversational AI system 302 can receive the natural language request via interface 314 (arrow 326) and can use the content of the request to retrieve one or more text tokens from knowledge database 310 that are semantically related to the request (arrow 328). For example, prompt generator 306 can convert the natural language request into an embedding and perform a similarity search of this embedding against the embeddings in the knowledge database 310, resulting in the identification of a set of embeddings and corresponding text tokens in the database that are most similar to the request.

Prompt generator 306 can then create a prompt for an LLM 330 that includes the natural language request, the retrieved text tokens, and a request to generate a transaction function string that is responsive to the natural language request and can submit this prompt to LLM 330 (arrow 332), thereby causing the LLM to output the requested transaction function string. As known in the art, an LLM is a type of generative AI model that is trained on large textual datasets and can interpret and generate natural language text. For example, listing 5 below presents a sample prompt that may be built by prompt generator 306 and submitted to LLM 330 for the natural language request presented in listing 4 above, where the prompt specifically asks the LLM to generate an OData transaction function string. In this sample prompt, the placeholder [TOKENS] would be replaced with the content of the text tokens retrieved by prompt generator 306 from knowledge database 310.

Listing 5

Please use the following retrieved knowledge, [TOKENS], that is
specific to this CRM business app, to generate an OData transaction
string for the task noted below. This knowledge contains information
on how the task is performed through a series of end-user
interactions with pages and UI controls, eventually executing the
OData transaction.
To generate the respective OData Transaction string in JavaScript
for the following task, please create a new variable for each new
parameter:
“Please search for the customer named ‘John Doe’ and update the
email address to ‘john.doe@abc.com’.”

And listing 6 below presents a sample output that may be generated by LLM 330 in response to the prompt of listing 5.

Listing 6

```
**Step 1: Fetch the customer**
let customerName = “John Doe”;
GET /odata/Customers?$filter-Name eq ‘${customerName}’
**Step 2: Update the customer**
let emailAddress = “john.doe@abc.com”;
PATCH /odata/Customers${ID}
And the request body would be:
  json
{
  “Email”: ‘${emailAddress}’
}
```

Finally, transaction initiator 308 can receive the transaction function string output by LLM 330 (arrow 334), match the string to a transaction function in transaction function list 312 that is closest to the string (arrow 336), and transmit an invocation of the matched transaction function to backend service 108 (arrow 338), resulting in execution of the corresponding data transaction by backend service 108 against data store 110. These steps of matching the transaction function string output by LLM 330 against transaction function list 112 and invoking the matched function in the list (rather than directly invoking the LLM output) serves as a sanity and security check to ensure that conversational AI system 302 only calls transaction functions that are explicitly coded into application 104 as part of its UI workflows.

With the general architecture and processes described above, conversational AI system 302 provides a number of benefits. First, by enabling users of application 104 such as user 106 to carry out application tasks via a natural language interface, system 302 provides a significantly more intuitive and user-friendly user interaction paradigm than traditional UI workflow-based approaches.

Second, because conversational AI system 302 automatically collects user interaction data on-the-fly while users interact with application 104 and uses this collected data for populating knowledge database 310 and transaction function list 312, there is no need to manually assemble or curate a training data set for training the system. Accordingly, system 302 can be brought online more efficiently than conventional machine learning systems.

Third, because conversational AI system 302 constructs transaction function list 312 and leverages list 312 for accurately executing data transactions against the application's data store 110 in response to user requests, system 302 provides transactional capabilities that go beyond the simple informational capabilities of conventional RAG systems.

It should be appreciated that the system architecture shown in FIG. 3 is illustrative and not intended to limit embodiments of the present disclosure. For example, although FIG. 3 depicts a particular arrangement of components in conversational AI system 302, other arrangements are possible. For example, the functionality attributed to a particular component may be split into multiple components. As another example, certain components may be combined or integrated into other components. One of ordinary skill in the art will recognize other variations, modifications, and alternatives.

### 2. Data Collection

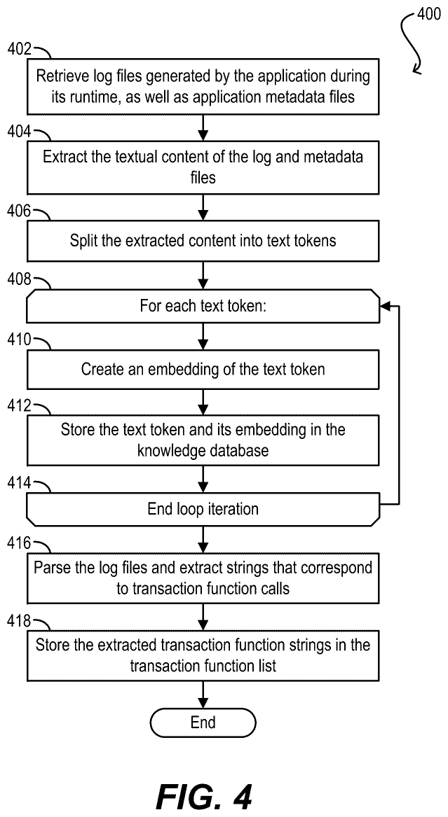

FIG. 4 is a flowchart 400 depicting steps that may be executed by data collector 304 of conversational AI system 302 for collecting user interaction data from application 104 according to certain embodiments. This data collection process may be carried out on a periodic basis during the runtime of application 104 while various application users access and interact with the application via the application's traditional UI workflows.

Starting with step 402, data collector 304 can retrieve log files that are generated by application 104 during its runtime, as well as metadata files of the application pertaining to its pages 112. The log files can include information regarding, e.g., the application tasks executed by the users, the pages each user navigates to, the UI controls that are manipulated by each user, and the transaction functions that are invoked. The metadata files can include information regarding, e.g., the layout and structure of UI controls/elements in each page of the application and the data and/or transaction function bindings for each UI control.

At steps 404 and 406, data collector 304 can extract the textual content of the log and metadata files and can split the extracted content into a plurality of text chunks, referred to as tokens. Data collector 304 can use any known text splitting algorithm for this purpose.

Upon creating the plurality of text tokens, data collector 304 can enter a loop for each token (step 408). Within the loop, data collector 304 can create an embedding of the text token, where the embedding is a vector-based representation of the token that preserves certain aspects of the token's original meaning (step 410). This can be achieved in various ways, such as by providing the text token as input to an embedding model that is specifically designed to create embeddings.

Data collector 304 can then store the text token and its corresponding embedding in knowledge database 310 (step 412), reach the end of the current loop iteration (step 414), and repeat steps 408-414 until all text tokens have been processed.

In addition to the foregoing, at step 416, data collector 304 can parse the log files retrieved at 402 and extract strings from the log files that correspond to transaction function calls to backend service 108. Finally, at step 418, data collector 304 can store the extracted transaction function strings in transaction function list 312 and the data collection process can end.

### 3. Natural Language Input Processing

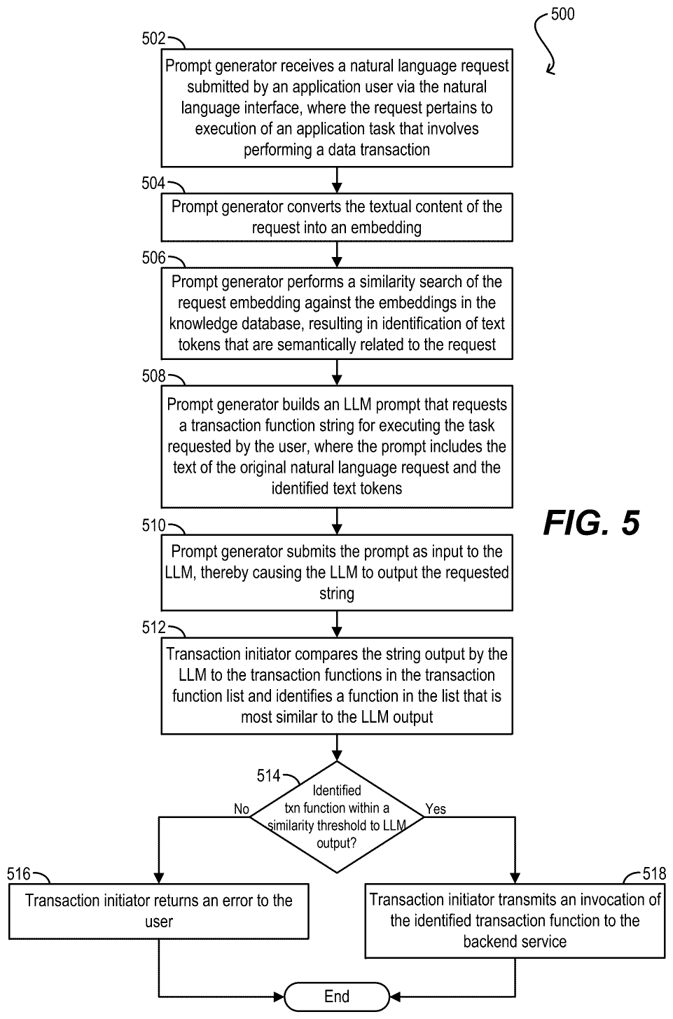

FIG. 5 is a flowchart 500 depicting steps that may be performed by prompt generator 306 and transaction initiator 308 of conversational AI system 302 for processing a user natural language request according to certain embodiments.

Starting with step 502, prompt generator 306 can receive a natural language request that is submitted by user 106 of application 104 via natural language interface 314. As mentioned previously, this request can pertain to the execution of a task within application 104 where the task involves performing a data transaction against data store 110 (e.g., updating the email address of a particular customer).

In response to receiving the natural language request, prompt generator 306 can convert the textual content of the request into an embedding (step 504) and can perform a similarity search of the request embedding against the embeddings stored in knowledge database 310, resulting in the identification of text tokens in database 310 that are semantically related to the request (step 506). The similarity search can involve, e.g., computing a mathematical distance (e.g., cosine distance) between the request embedding and the embeddings in knowledge database 310 and identifying the embeddings (and thus, text tokens) that are closest in distance to the request embeddings.

Prompt generator 306 can then build an LLM prompt that requests a transaction function string for executing the task specified in the user's natural language request, where the LLM prompt includes both the text of the original natural language request and the identified text tokens as context (step 508), and can submit the prompt as input to LLM 330, thereby causing the LLM to output the requested transaction function string (step 510).

At step 512, transaction initiator 308 can compare the string output by LLM 330 to the transaction functions in transaction function list 312 and can identify the transaction function in the list that is most similar to the LLM output. Transaction initiator 308 can thereafter check whether the identified transaction function is within a certain similarity threshold to the string output by LLM 330 (step 514). This similarity threshold may be configured by, e.g., an administrator of conversational AI system 302.

If the answer at step 514 is no (i.e., the identified transaction function is not sufficiently similar to the LLM output), an error can be returned to user 106 (step 516). However, if the answer at step 514 is yes (i.e., the identified transaction function is sufficiently similar to the LLM output), transaction initiator 308 can transmit an invocation of the identified transaction function to backend service 108, thereby causing backend service 108 to execute the transaction corresponding to that transaction function against data store 110 (step 518). As part of step 518, transaction initiator 308 can include in the transaction function invocation any parameter names and/or values specified in the LLM output (e.g., a particular email address, a particular customer name, etc.).

### 4. Example Computer System

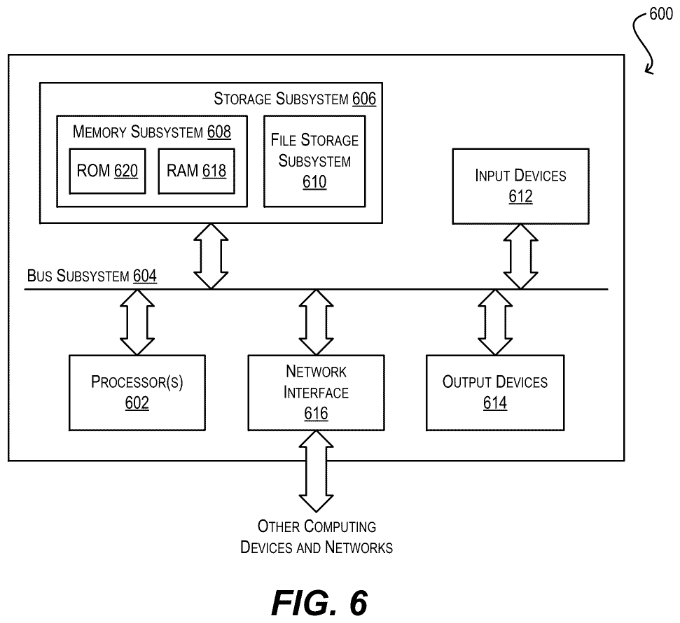

FIG. 6 is a simplified block diagram of an example computer system 600 according to certain embodiments. Computer system 600 (and/or equivalent systems/devices) may be used to run any of the software described in the foregoing disclosure, conversational AI system 302 and its constituent components. As shown in FIG. 6, computer system 600 includes one or more processors 602 that communicate with a number of peripheral devices via a bus subsystem 604. These peripheral devices include a storage subsystem 606 (comprising a memory subsystem 608 and a file storage subsystem 610), user interface input devices 612, user interface output devices 614, and a network interface subsystem 616.

Bus subsystem 604 can provide a mechanism for letting the various components and subsystems of computer system 600 communicate with each other as intended. Although bus subsystem 604 is shown schematically as a single bus, alternative embodiments of the bus subsystem can utilize multiple buses.

Network interface subsystem 616 can serve as an interface for communicating data between computer system 600 and other computer systems or networks. Embodiments of network interface subsystem 616 can include, e.g., an Ethernet module, a Wi-Fi and/or cellular connectivity module, and/or the like.

User interface input devices 612 can include a keyboard, pointing devices (e.g., mouse, trackball, touchpad, etc.), a touch-screen incorporated into a display, audio input devices (e.g., voice recognition systems, microphones, etc.), motion-based controllers, and other types of input devices. In general, use of the term “input device” is intended to include all possible types of devices and mechanisms for inputting information into computer system 600.

User interface output devices 614 can include a display subsystem and non-visual output devices such as audio output devices, etc. The display subsystem can be, e.g., a transparent or non-transparent display screen such as a liquid crystal display (LCD) or organic light-emitting diode (OLED) display that is capable of presenting 2D and/or 3D imagery. In general, use of the term “output device” is intended to include all possible types of devices and mechanisms for outputting information from computer system 600.

Storage subsystem 606 includes a memory subsystem 608 and a file/disk storage subsystem 610. Subsystems 608 and 610 represent non-transitory computer-readable storage media that can store program code and/or data which provide the functionality of embodiments of the present disclosure in a non-transitory state.

Memory subsystem 608 includes a number of memories including a main random access memory (RAM) 618 for storage of instructions and data during program execution and a read-only memory (ROM) 620 in which fixed instructions are stored. File storage subsystem 610 can provide persistent (i.e., non-volatile) storage for program and data files, and can include a magnetic or solid-state hard disk drive, an optical drive along with associated removable media (e.g., CD-ROM, DVD, Blu-Ray, etc.), a removable or non-removable flash memory-based drive, and/or other types of non-volatile storage media known in the art.

It should be appreciated that computer system 600 is illustrative and other configurations having more or fewer components than computer system 600 are possible.

The above description illustrates various embodiments of the present disclosure along with examples of how aspects of these embodiments may be implemented. The above examples and embodiments should not be deemed to be the only embodiments and are presented to illustrate the flexibility and advantages of the present disclosure as defined by the following claims. For example, although certain embodiments have been described with respect to particular workflows and steps, it should be apparent to those skilled in the art that the scope of the present disclosure is not strictly limited to the described workflows and steps. Steps described as sequential may be executed in parallel, order of steps may be varied, and steps may be modified, combined, added, or omitted. As another example, although certain embodiments may have been described using a particular combination of hardware and software, it should be recognized that other combinations of hardware and software are possible, and that specific operations described as being implemented in hardware can also be implemented in software and vice versa.

The specification and drawings are, accordingly, to be regarded in an illustrative rather than restrictive sense. Other arrangements, embodiments, implementations, and equivalents will be evident to those skilled in the art and may be employed without departing from the spirit and scope of the present disclosure as set forth in the following claims.

What is claimed is:

1. A method performed by one or more computer systems, the method comprising:
collecting user interaction data from a software application while one or more users interact with one or more user interfaces (UIs) of the software application, the user interaction data pertaining to interactions between the one or more users and the one or more UIs and identifying one or more transaction functions invoked by the software application in response to the interactions;
populating a knowledge database and a transaction function list using the user interaction data;
receiving, from a user, a natural language request to perform a task within the software application, the task involving execution of a data transaction;
retrieving one or more text tokens from the knowledge database that are semantically related to the natural language request;
building a large language model (LLM) prompt that includes the natural language request, the one or more text tokens, and a request to generate a transaction function string that is responsive to the natural language request;
submitting the LLM prompt as input to an LLM, thereby causing the LLM to output the transaction function string;
matching the transaction function string to a transaction function in the transaction function list; and
invoking the transaction function, resulting in execution of the data transaction.

2. The method of claim 1 wherein the interactions include accessing the one or more UIs and interacting with one or more UI controls presented in the one or more UIs.

3. The method of claim 1 wherein the user interaction data is collected from one or more log files generated by the software application while the one or more users interact with the one or more UIs.

4. The method of claim 3 wherein the user interaction data is further collected from one or more metadata files of the software application.

5. The method of claim 1 wherein the user interaction data includes a set of pages the one or more users navigate to, a set of UI controls manipulated by the one or more users, and a set of data entered by the one or more users.

6. The method of claim 1 wherein populating the knowledge database comprises:
splitting textual content of the user interaction data into a plurality of text tokens; and
for each text token in the plurality of text tokens:
creating an embedding of the text token; and
storing the text token and the embedding in the knowledge database.

7. The method of claim 6 wherein the embedding is created by providing the text token as input to an embedding model separate from the LLM.

8. The method of claim 6 wherein retrieving the one or more text tokens from the knowledge database comprises:
creating a user embedding from the natural language request;
performing a similarity search of the user embedding against the embeddings stored in the knowledge database, the similarity search resulting in identification of one or more embeddings and associated text tokens in the knowledge database that are semantically related to the natural language request; and
retrieving the associated text tokens.

9. The method of claim 1 wherein the natural language request is submitted by the user via voice input.

10. The method of claim 1 wherein the natural language request is submitted by the user via text input.

11. The method of claim 1 wherein the transaction function is exposed by a backend service that is communicatively coupled with the software application.

12. The method of claim 11 wherein the data transaction is executed by the backend service in response to the invoking of the transaction function.

13. The method of claim 1 wherein the data transaction involves querying data from or writing data to a backend data store.

14. The method of claim 1 wherein the transaction function is an OData transaction function and the transaction is an OData transaction.

15. A non-transitory computer readable storage medium having stored thereon instructions executable by one or more processors, the instructions causing the one or more processors to:
collect user interaction data from a software application while one or more users interact with one or more user interfaces (UIs) of the software application, the user interaction data pertaining to interactions between the one or more users and the one or more UIs and identifying one or more transaction functions invoked by the software application in response to the interactions;
populate a knowledge database and a transaction function list using the user interaction data;
receive, from a user, a natural language request to perform a task within the software application, the task involving execution of a data transaction;
retrieve one or more text tokens from the knowledge database that are semantically related to the natural language request;
build a large language model (LLM) prompt that includes the natural language request, the one or more text tokens, and a request to generate a transaction function string that is responsive to the natural language request;
submit the LLM prompt as input to an LLM, thereby causing the LLM to output the transaction function string;
match the transaction function string to a transaction function in the transaction function list; and
invoke the transaction function, resulting in execution of the data transaction.

16. The non-transitory computer readable storage medium of claim 15 wherein populating the knowledge database comprises:
splitting textual content of the user interaction data into a plurality of text tokens; and
for each text token in the plurality of text tokens:
creating an embedding of the text token; and
storing the text token and the embedding in the knowledge database.

17. The non-transitory computer readable storage medium of claim 16 wherein retrieving the one or more text tokens from the knowledge database comprises:
creating a user embedding from the natural language request;
performing a similarity search of the user embedding against the embeddings stored in the knowledge database, the similarity search resulting in identification of one or more embeddings and associated text tokens in the knowledge database that are semantically related to to the natural language request; and
retrieving the associated text tokens.

18. A computer system comprising:
one or more processors; and
a computer readable storage medium having stored thereon program code that, when executed by the one or more processors, cause the one or more processors to:
collect user interaction data from a software application while one or more users interact with one or more user interfaces (UIs) of the software application, the user interaction data pertaining to interactions between the one or more users and the one or more UIs and identifying one or more transaction functions invoked by the software application in response to the interactions;
populate a knowledge database and a transaction function list using the user interaction data;
receive, from a user, a natural language request to perform a task within the software application, the task involving execution of a data transaction;
retrieve one or more text tokens from the knowledge database that are semantically related to the natural language request;
build a large language model (LLM) prompt that includes the natural language request, the one or more text tokens, and a request to generate a transaction function string that is responsive to the natural language request;
submit the LLM prompt as input to an LLM, thereby causing the LLM to output the transaction function string;
match the transaction function string to a transaction function in the transaction function list; and
invoke the transaction function, resulting in execution of the data transaction.

19. The computer system of claim 18 wherein populating the knowledge database comprises:
splitting textual content of the user interaction data into a plurality of text tokens; and
for each text token in the plurality of text tokens:
creating an embedding of the text token; and
storing the text token and the embedding in the knowledge database.

20. The computer system of claim 19 wherein retrieving the one or more text tokens from the knowledge database comprises:
creating a user embedding from the natural language request;
performing a similarity search of the user embedding against the embeddings stored in the knowledge database, the similarity search resulting in identification of one or more embeddings and associated text tokens in the knowledge database that are semantically related to to the natural language request; and
retrieving the associated text tokens.
